(19) United States
(12) Patent Application Publication
(10) Pub. No.: US 2026/0289741 A1
(43) Pub. Date: Sep. 24, 2026

(54) Automated Generation And Use Of Enhanced Dwelling Images Using Machine Learning Models Of Multiple Types

(71) Applicant: MFTB Holdco, Inc., Seattle, WA (US)

(72) Inventors: Lambert E. Wixson, Bellevue, WA (US); Zachary S. Bessinger, Crestwood, KY (US)

(21) Appl. No.: 19/575,895

(22) Filed: Mar. 23, 2026

Related U.S. Application Data
(60) Provisional application No. 63/776,895, filed on Mar. 24, 2025.

(51) Int. Cl. G06T 5/60; G06T 11/10; G06V 10/26; G06V 10/764; G06V 10/774

(52) U.S. Cl. CPC G06T 5/60; G06T 11/10; G06V 10/26; G06V 10/764; G06T 2207/10024; G06T 2207/20081; G06V 10/774

(57) ABSTRACT

Techniques are described for performing automated operations to generate and use enhanced dwelling images based on multiple trained machine learning (ML) models of multiple types, such as to provide improved search results based at least in part on the enhanced dwelling images and on the objects identified within them. The multiple trained ML models may include a trained semantic segmentation ML model to identify objects in a dwelling image, and a trained diffusion ML model to generate an enhanced version of the dwelling image with modifications to one or more of the objects, such as to improve clarity and/or visibility and/or other attributes of those objects. The determination of which objects to modify in a dwelling image and how to modify those objects may be made in various manners in various embodiments, including based on an automated analysis of visual data of the dwelling image in some embodiments.

### CROSS REFERENCE TO RELATED APPLICATIONS

This application claims the benefit of U.S. Provisional Patent Application No. 63/776,895, filed Mar. 24, 2025 and entitled “Automated Generation And Use Of Enhanced Dwelling Images Using Machine Learning Models Of Multiple Types”, which is hereby incorporated by reference in its entirety.

### TECHNICAL FIELD

The following disclosure relates generally to techniques for automatically generating and using enhanced dwelling images based on multiple trained machine learning models of multiple types, such as to automatically use a trained semantic segmentation model to identify objects in a dwelling image and to use a trained diffusion model to generate an enhanced version of the dwelling image with modifications to one or more of the objects, and to respond to search queries for dwellings using such enhanced dwelling images and the objects identified within them.

### BACKGROUND

An abundance of information is available to users on a wide variety of topics from a variety of sources. For example, portions of the World Wide Web (“the Web”) are akin to an electronic library of documents and other data resources distributed over the Internet, with billions of documents available, including groups of documents directed to various specific topic areas (e.g., buildings of various types). In addition, various other information is available via other communication mediums. However, existing search engines and other techniques for identifying information of interest suffer from various problems. Non-exclusive examples include a difficulty in understanding natural language requests, difficulty in providing accurate information that is specific to a particular topic of interest and/or useful to a particular user, difficulty in limiting information requests to approved topics, etc.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1B are network diagrams illustrating an example system for performing described techniques, including automatically generating and using enhanced dwelling images based on multiple trained machine learning models of multiple types.

FIG. 1C illustrates examples of non-exclusive types of dwelling description information.

FIGS. 2A-2C illustrate examples of performing described techniques, including automatically generating and using enhanced dwelling images based on multiple trained machine learning models of multiple types.

FIG. 3 is a block diagram illustrating an example of a computing system for use in performing described techniques, including automatically generating and using enhanced dwelling images based on multiple trained machine learning models of multiple types.

FIGS. 4A-4B illustrate a flow diagram of an example embodiment of an Automated Dwelling Image Enhancement (“ADIE”) system routine.

FIG. 5 illustrates a flow diagram of an example embodiment of an ADIE Enhanced Image Generator component routine.

FIG. 6 illustrates a flow diagram of an example embodiment of a client device routine.

### DETAILED DESCRIPTION

The present disclosure describes techniques for using computing devices to perform automated operations involving automatically generating and using enhanced dwelling images based on multiple trained machine learning models of multiple types, such as to provide improved search results that are based at least in part on the enhanced dwelling images and on the objects identified within them. In at least some embodiments, the multiple trained machine learning (ML) models of multiple types include a trained semantic segmentation ML model to identify objects in a dwelling image, and a trained diffusion ML model to generate an enhanced version of the dwelling image with modifications to one or more of the objects, such as to improve clarity and/or visibility and/or other attributes of those objects. The semantic segmentation ML model may, for example, be a vision-language neural network model that embeds and associates visual features and textual descriptions of known object classes, such as for a plurality of object classes on which the model was trained (including in some embodiments for the semantic segmentation model to be trained on objects specific to dwellings), including to analyze an input image and assign a label classification to a pixel for a predicted object class (or other visible element), as well as to produce a visual image mask for an object showing contiguous regions of pixels having the same assigned object label. The diffusion ML model may, for example, use a transformer neural network architecture to denoise portions of a dwelling image corresponding to objects whose visual data has been modified, such as to remove visual artifacts introduced by the modification. The determination of which objects to modify in a dwelling image and how to modify those objects may be made in various manners in various embodiments, including based on an automated analysis of visual data of the dwelling image in some embodiments, as discussed further herein. Additional details are included below regarding automatically generating and using enhanced dwelling images based on multiple trained machine learning models of multiple types, and some or all of the techniques described herein may, in at least some embodiments, be performed via automated operations of an Automated Dwelling Image Enhancement (“ADIE”) system, as discussed further below.

As noted above, the generation of the enhanced images may include identifying objects and optionally other visible elements in dwelling images, and modifying visual data in the dwelling images corresponding to selected objects and optionally other visible elements. Non-exclusive examples of types of objects associated with dwellings include structural elements (e.g., windows, doorways, non-doorway wall openings, walls, floors, ceilings, stairways, built-in structures such as fireplaces and kitchen islands and exposed beams, etc.) and other objects in dwelling rooms (e.g., installed fixtures, appliances, cabinets, switches and other controls, furniture, etc.) and/or within dwelling exteriors (e.g., on the dwelling exterior surface and/or on a surrounding property, such as porch swings, driveways, sidewalks, outbuildings, gardens and other plants and flora, etc.). Non-exclusive examples of other types of visible elements associated with dwellings include types or categories of surfaces (e.g., types of floor coverings, such as tile or carpet or hardwood or laminate; types of wall coverings, such as paint or stucco or siding; types of roof coverings, such as shingles or metal or tile; other types of surface coverings, such as for kitchen islands or cabinets or vanities; etc.). While the remainder of the document will refer generally to “object” types and associated object classes identified by a trained semantic segmentation ML model, the “object” term as used herein is intended to include objects and other visible elements unless otherwise indicated explicitly or by context.

In addition, in at least some embodiments, the automated operations of the ADIE system further include validating an enhanced image that is generated before further using the enhanced image, such as further using it in generating and/or providing search results, or otherwise presenting the enhanced image. In at least some embodiments, the validating of such an enhanced image that is generated from an original target dwelling image may include performing semantic segmentation on the enhanced image to identify objects visible in the enhanced image, and comparing that semantic segmentation to the prior semantic segmentation of the original target dwelling image (e.g., using a pixel-wise cross-entropy metric; measuring differences between outlines of visible objects, such as from corresponding visual pixel masks; etc.) to verify that they differ by at most a defined threshold amount (e.g., to verify that the modifying of the visual data of the original target dwelling image does not alter the boundaries of the visible objects).

The described automated techniques provide various benefits in various embodiments, including to significantly improve the ability to identify objects that are recognized in dwelling images by a semantic segmentation machine learning model and that are modified in resulting enhanced images, as well as to use such identified dwelling-object information in various manners (e.g., in response to specified queries for information about dwellings satisfying one or more specified criteria, including queries specified in a natural language format), and to significantly improve functionality for controlling the generation of enhanced images for associated dwellings in particular specified manners. Such automated techniques also allow such enhanced images to be generated more efficiently (e.g., using less storage and/or memory and/or computing cycles) and with greater accuracy, based at least in part on using the multiple trained machine learning models of multiple types in particular manners as described herein (e.g., in a particular order, and to perform specified actions). In addition, in some embodiments the described techniques may be used to provide an improved GUI (graphical user interface) in which a user may more accurately and quickly obtain real estate-related information, including in response to an explicit request (e.g., in the form of a natural language query), as part of providing personalized information to the user, etc. Various other benefits are also provided by the described techniques, some of which are further described elsewhere herein.

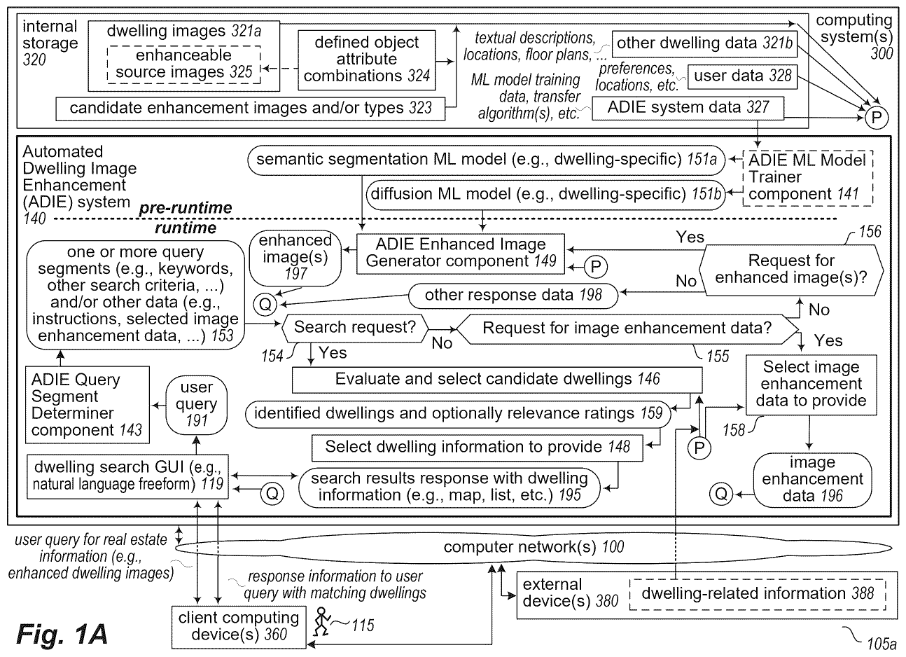

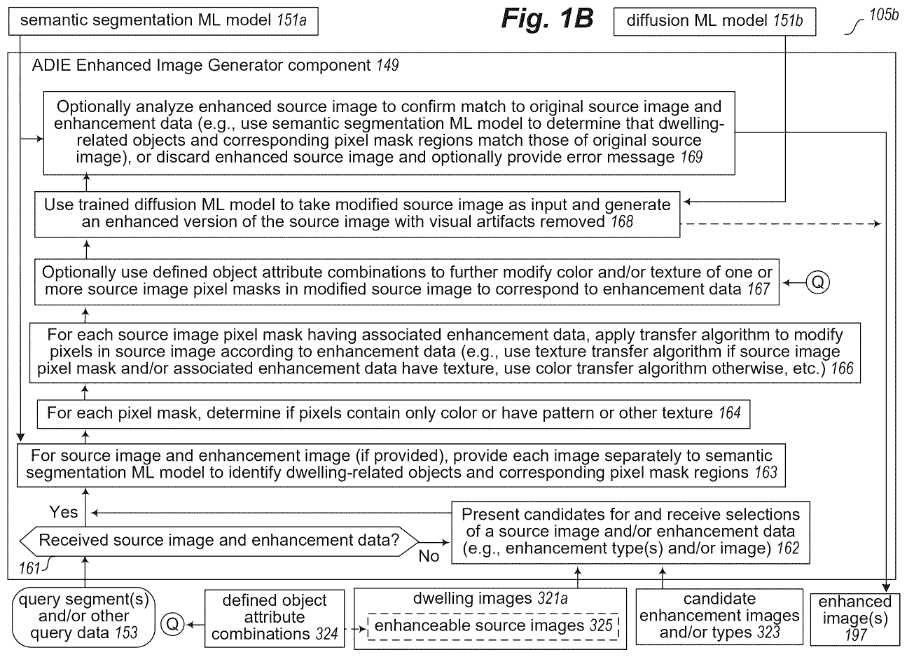

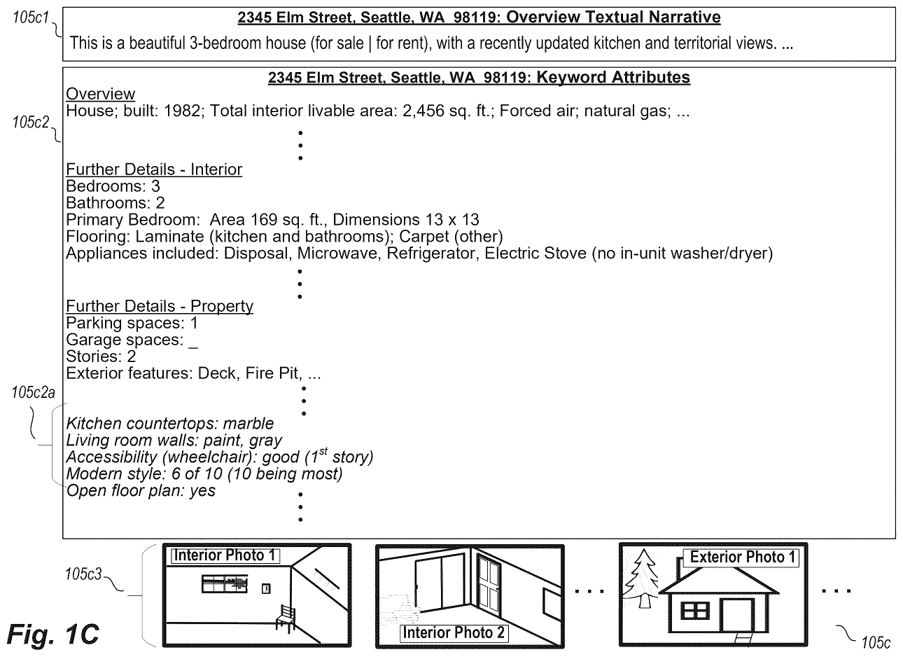

FIGS. 1A-1B are network diagrams illustrating an example system for performing described techniques, including automatically generating and using enhanced dwelling images based on multiple trained machine learning models of multiple types.

In particular, FIG. 1A illustrates information 105a about an example embodiment of an ADIE system 140 executing on one or more computing systems 300, and interacting over one or more computer networks 100 with one or more client computing devices 360, such as to receive query requests from users 115 of the client computing devices for information about dwellings and to provide corresponding responses with requested dwelling information (e.g., as part of search results), as well as to receive instructions regarding generating new enhanced images. In the illustrated embodiment, the computing systems 300 may store various information on storage 320 that is used by the ADIE system during operation (e.g., in one or more databases), including dwelling data 321 about dwellings in one or more geographical areas (e.g., in one or more countries, states, cities, etc., such as dwelling images 321a and other dwelling information 321b including information about objects identified in dwellings from analysis of dwelling images as well as other information such as textual building descriptions of the dwellings), user data 328 (e.g., user location; user preferences, such as expressly specified and/or implicitly determined from past activities of the user such as viewing or otherwise interacting with information about dwellings; prior and/or concurrent search interaction sessions with the user; etc.), and ADIE system data 327 (e.g., training data for semantic segmentation ML models and/or diffusion ML models, search comparison thresholds, enhanced image validation comparison thresholds, predefined keywords, information for use in segment determination such as word-break and/or phrase-break vocabularies, etc.). The ADIE system may further optionally retrieve and use other dwelling-related information 388 of one or more types stored externally to the computing systems 300 (e.g., from one or more public and/or private information sources), such as accessed over the one or more computer networks 100 from one or more external computing and/or storage devices 380, whether in addition to or instead of information stored on storage 320.

As one example of operations of the ADIE system 140, an ADIE ML Model Trainer component 141 may optionally obtain ML model training data from the ADIE system data 327 (e.g., dwelling-specific object semantic segmentation data examples, such as positive and/or negative examples; dwelling-specific object diffusion data, such as dwelling images with progressively increasing levels of noise; etc.), and generate one or more resulting trained ML models 151 (e.g., 151a, 151b, etc.) for subsequent use (e.g., a trained semantic segmentation ML model 151a, such as one trained in a dwelling-specific manner to identify objects typically found in and around dwellings; a trained diffusion ML model 151b, such as one trained in a dwelling-specific manner to generate visual renditions of objects typically found in and around dwellings; etc.). In other embodiments, a pretrained semantic segmentation ML model 151a and/or a pretrained diffusion ML model 151b may be used, whether pretrained in a manner specific to dwellings or not. The ADIE system 140 then uses the multiple trained ML models 151 as part of generating enhanced images, including in response to received user instructions, as described further below.

During further operations of the ADIE system 140, a particular user 115 of one of the client computing devices 360 may supply a query 191 about one or more dwellings to a GUI 119 provided by the ADIE system (e.g., as natural language free-form input). The GUI provides the user query to an ADIE Query Segment Determiner component 143, which analyzes the user query to attempt to identify segments within the query corresponding to one or more search criteria or to other instructions or data, such as to optionally include indications of instructions and/or associated input data for use in generating an enhanced image, as well as to optionally include other types of search criteria (e.g., keyword-based query segments, additional query segments that do not include any predefined keywords or indications of new object classes, etc.)—if the component 143 is unable to identify such segments or other data, such as due to the received query lacking a correct format or types of information or due to having other problems, the component instead may generate and return a clarifying query response (not shown) to the GUI 119 to request further information from the user and/or to indicate an inability to respond. Otherwise, the system 140 determines in block 154 if the data 153 from the user query 191 is part of a search request, and if so forwards the determined query segments and/or other data 153, along with user data 328, dwelling data 321 and optionally types of ADIE system data 327 other than training data (e.g., search comparison thresholds), to evaluate and select candidate dwellings and to select identified dwellings 159 that match the search criteria of the user query 191, optionally along with relevance ratings for some or all of the identified dwellings. The identified dwellings 159 are then used to select and generate information specific to the identified dwellings 148 to include as part of a search results response with target dwelling information 195, such as to filter and/or rank the identified dwellings (e.g., based on the relevance ratings), to select types of information to include for a dwelling, to format the search results in a particular manner (e.g., in a list format or overlaid on a map), etc. After the query response 195 with the dwelling information is generated, or if the component 143 instead generates a clarifying query response without forwarding the query segments 153 to the component 146, the generated query response 195 or clarifying query response is provided via the GUI 119 to the client computing device of the user who submitted the query, such as for display on the client computing device as part of the GUI.

If the system 140 instead determines in block 154 that the data 153 from the user query 191 is not part of a search request, the system determines in block 155 if the user query 191 includes a request to receive information for image enhancement data, such as to provide options for generating an enhanced image (e.g., one or more source dwelling images from which to generate an enhanced image, optionally with one or more preselected objects that are available to be enhanced, and/or optionally for one or more specific indicated dwellings; one or more types of objects to modify as part of an enhanced image, optionally with one or more source dwelling images that include object(s) of the object type(s), and/or optionally for one or more specific indicated dwellings; one or more example enhancement images that illustrate types of modifications to objects; etc.). If so, the system 140 in block 158 selects corresponding image enhancement data 196 to provide, such as using dwelling data 321 and/or user data 328 and/or ADIE system data 327, and proceeds to provide that data 196 via the GUI 119 to the client computing device of the user who submitted the query, such as for display on the client computing device as part of the GUI.

If the system 140 instead determines in block 155 that the data 153 from the user query 191 is not part of a request for image enhancement data, the system determines in block 156 if the user query 191 includes a request to generate an enhanced image based on associated instructions that are provided, and if not generates other response data 198. Otherwise, the system 140 proceeds to perform the ADIE Enhanced Image Generator component 149 to generate one or more such enhanced images 197, including using the data supplied in the user query and optionally dwelling data 321 and/or user data 328 and/or ADIE system data 327 to do so—FIG. 1B provides one example of automated operations of such a component 149. The system then proceeds to provide the enhanced image(s) 197 or other response data 198 via the GUI 119 to the client computing device of the user who submitted the query, such as for display on the client computing device as part of the GUI.

The same user may then provide one or more subsequent queries 191 to the GUI 119 as part of an ongoing interaction session, such as with similar processing performed for the subsequent user queries, and optionally with the context of prior interactions during the session being maintained and used by the ADIE system (e.g., stored and used to add missing information in later queries, such as dwelling type or geographical area; stored and used to personalize responses generated for such subsequent queries, etc.). In addition, a user may in some embodiments and situations provide optional user feedback (not shown), such as to indicate that incorrect search criteria have been determined for the user query, to otherwise provide feedback regarding accuracy of search results response 195 or other response data 196, 197 and/or 198 or to provide further clarifying information in response to a clarifying query response, to specify further user preferences to be used, etc. If so, such optional user feedback may be forwarded to some or all of the system 140 components, such as to improve future determinations performed by the components. In other embodiments and situations, some or all such feedback may instead be implicit feedback that is determined based on an analysis of subsequent user queries (e.g., to indicate that a prior query response did not provide information that the user was seeking) and/or of prior user queries (e.g., to determine user preferences and/or user location, such as based on patterns in the prior user queries). While the example discussed above involves a single user performing multiple interactions with the ADIE system as part of an interaction session (e.g., spanning seconds, minutes, hours, days, etc.), it will be appreciated that the ADIE system may in at least some embodiments and situations be concurrently interacting with many users using different client computing devices, such as to maintain separate GUIs and interaction session histories for such users, and that a new interaction session may be initiated for a user after one or more prior interaction sessions with that user in various manners (e.g., based on a corresponding user instruction, such as to reflect a change in the types of dwelling information of interest; as determined automatically by the ADIE system, such as to reflect a change in the types of dwelling information being requested, or due to a defined period of time since a last user interaction being exceeded, such as one or more days; etc.).

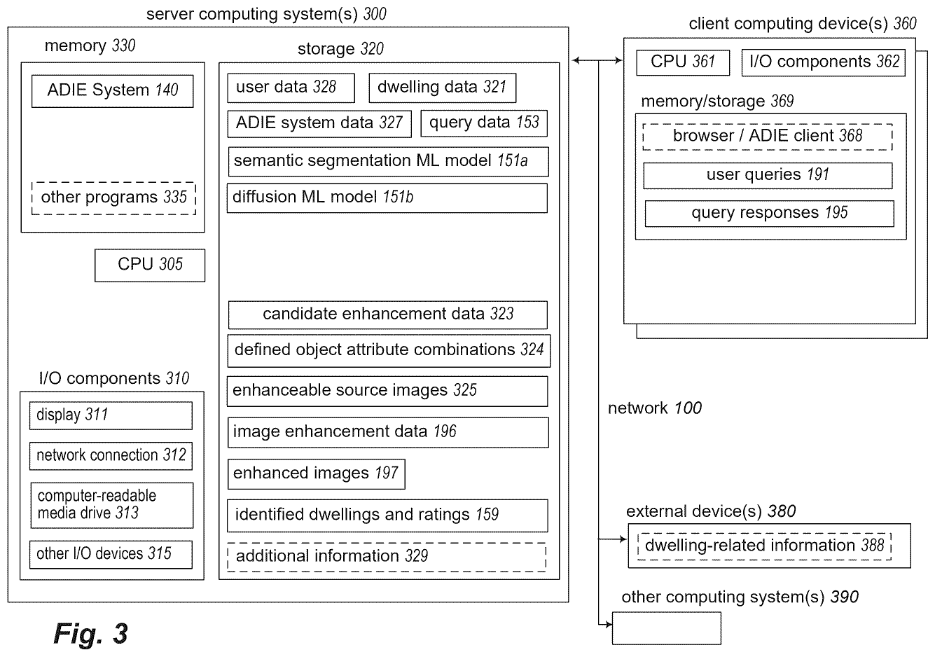

In addition, the computing system(s) 300 may include various other components and functionality, as discussed in greater detail elsewhere herein, including with respect to FIG. 3. The computer networks 100 may similarly be of various types in various embodiments and may include various types of wired and/or wireless segments, including one or more publicly accessible linked networks (e.g., operated by various distinct parties, such as the Internet) and/or a private network (e.g., a corporate or university network that is wholly or partially inaccessible to non-privileged users), including in some cases to have both private and public networks (e.g., with one or more of the private networks having access to and/or from one or more of the public networks).

FIG. 1B continues the example of FIG. 1A, and illustrates information 105b for one example embodiment of the ADIE Enhanced Image Generator component 149 discussed in FIG. 1A. In particular, the component 149 performs various activities in the illustrated embodiment to generate and provide one or more such enhanced images 197, including using data supplied in the user query and optionally additional dwelling data 321 and/or user data 328 and/or ADIE system data 327 to do so.

In operation, the component 149 receives, as input, data 153 from the received user query, which may include instructions related to generating one or more enhanced images (e.g., for use in controlling types of modifications to make to types of objects), and optionally additional image enhancement data (e.g., a source image to be enhanced, and/or one or more enhancement images from which to use visual data in modifying the source image, and/or indications of one or more objects in the source image to modify, and/or indications of one or more types of modifications to make to one or more indicated objects, etc.)—in at least some embodiments and situations, some or all of the input data 153 may be included based on selections previously made by a user from candidate options provided to the user in a GUI. In block 161, the component determines if the data received from the user query includes a source image and sufficient image enhancement data to specify how to modify the source image to generate one or more resulting enhanced images (e.g., data for multiple defined types, such as which one or more objects to modify in which source image, how to modify such an object, etc.), and if so proceeds to block 163. Otherwise, the component continues to block 162, where it determines and presents candidates to the user for a source image (if not already specified) and/or for image enhancement data of one or more types (if not already specified), and receives corresponding selections from the user (e.g., using enhanceable source images 325 or other dwelling images 321a; candidate enhancement images and/or enhancement types 323; a list of object types, such as corresponding to objects visible in provided dwelling images or more generally associated with particular dwelling rooms or other areas; etc.), and then proceeds to block 163. In block 163, the routine then, for the indicated source image and any enhancement images that are provided, supplies an image separately to the semantic segmentation ML model to cause it to identify dwelling-related objects and corresponding visual pixel mask regions in that image. In block 164, the component then, for a visual pixel mask from block 163 (or at least those corresponding to indicated objects or object types to be modified), determines if the pixels within that mask contain only consistent color data (e.g., accounting for shading or otherwise for differing light conditions) or instead have a pattern or other texture across the visual pixel mask. In block 166, the component then, for a source image visual pixel mask of an object type to be modified and having associated enhancement data to use for the modification, applies a transfer algorithm to modify pixels in the source image for that pixel mask according to the associated enhancement data (e.g., to use a texture transfer algorithm if the source image pixel mask and/or associated enhancement data for that pixel mask contain patterns or other texture data, or to otherwise use a color transfer algorithm).

In block 167, the component then optionally uses defined object attribute combination data 324 to further modify the color and/or texture of one or more source image pixel masks in the modified source image resulting from block 166 in order to correspond to further enhancement data—in at least some embodiments and situations, such further enhancement data may include combinations of colors and/or textures to use in different associated types of objects (e.g., if an upper cabinet color is specified to be X, then use a complementary or contrasting Y color for the backsplash or wall paint color; if a countertop has a pattern or other texture corresponding to a particular type of natural stone or butcher block, then use a complementary or contrasting specified color or texture for the flooring; etc.). After block 167, the component in block 168 uses a trained diffusion ML model to take the current modified source image as input and to generate an enhanced version of the source image with visual artifacts removed, such as based on providing corresponding instructions to modify only visual data for the objects in the modified source image that had been previously modified and/or to remove only visual artifacts without making other changes. In block 169, the component then optionally analyzes the enhanced source image to validate it, such as to confirm a match to the original source image and enhancement data (e.g., to ensure that the diffusion model has not made changes other than those instructed), and if such validation is performed and fails, the component may further discard the enhanced source image and optionally provide a corresponding error message, or may otherwise restart the process at block 161 with changed instructions (e.g., for the trained diffusion ML model) and/or changed enhancement data—in some embodiments and situations, the validation may include using the semantic segmentation ML model to determine that dwelling-related objects and corresponding pixel masks regions in the enhanced source image match those of the original source image within a defined amount of difference. After block 169 if the enhanced source image is validated, or after block 168 if the validation is not performed, the component then provides the enhanced image(s) 197 as output.

FIG. 1C illustrates examples of non-exclusive types of dwelling description information 105c that may be available in some embodiments for an example dwelling (in this example, a house available for rental and/or purchase), such as existing building information that is supplemented by the ADIE system with object data identified from image analysis, and that is subsequently analyzed and used by the ADIE system (e.g., in responding to search and browse query requests). In the example of FIG. 1C, the dwelling description information 105c includes an overview textual narrative description 105c1, various keyword attribute data 105c2, and various associated images or other digital media items or content pieces 105c3, such as may be used in part or in whole as listing information for an MLS (multiple listing service) system. In this example, the attribute data is grouped into sections (e.g., overview attributes, further interior detail attributes, further property detail attributes, etc.), with most of the attribute data specified using keyword-value pairs having a keyword and at least one corresponding value (although other attributes may be specified using a keyword without any associated values, such as based on the presence or absence of a keyword such as “deck” or “pool”)—in other embodiments, the attribute data may not be grouped or may be grouped in other manners and may be specified in other manners, including for the dwelling description information to not be separated into a list of attributes and a separate overview textual narrative description. In this example, the separate overview textual narrative description emphasizes characteristics that may be of interest to viewers, such as a dwelling style type, information of interest about rooms and other dwelling characteristics (e.g., have been recently updated or have other characteristics of interest), information of interest about the property and surrounding neighborhood or other environment, etc. In addition, in this example, the attribute data includes objective attributes of a variety of types about rooms and the dwelling and limited information about appliances or other objects, but may initially lack details of various types shown in italics in this example for attributes 105c2a, including for objects subsequently identified for dwellings from image analysis (e.g., the type of kitchen countertops, the types of wall coverings in rooms such as the living room, etc.) and optionally for other data identified via image analysis (e.g., about subjective attributes, such as having an open floor plan, being accessible, having a type of style, etc.; about inter-room connectivity and other adjacency; etc.), such as may instead be determined by the ADIE system via analysis of dwelling images and/or other building information (e.g., floor plans), and/or may lack details of various types shown in italics in this example for attributes 105c2a (e.g., about subjective attributes; about attributes associated with rental usage policies, such as if the dwelling is only available for acquisition; etc.). In addition, in this example, the digital media items or other content pieces 105c3 include multiple dwelling images (both inside and outside in this example), but do not include various other types of digital media items that may be present in some embodiments for at least some dwellings (e.g., a 2D floor plan, a 3D computer model floor plan, audio clips, video clips, a virtual tour of inter-linked images through which a viewer may progress in a user-selected and/or automated manner, etc.).

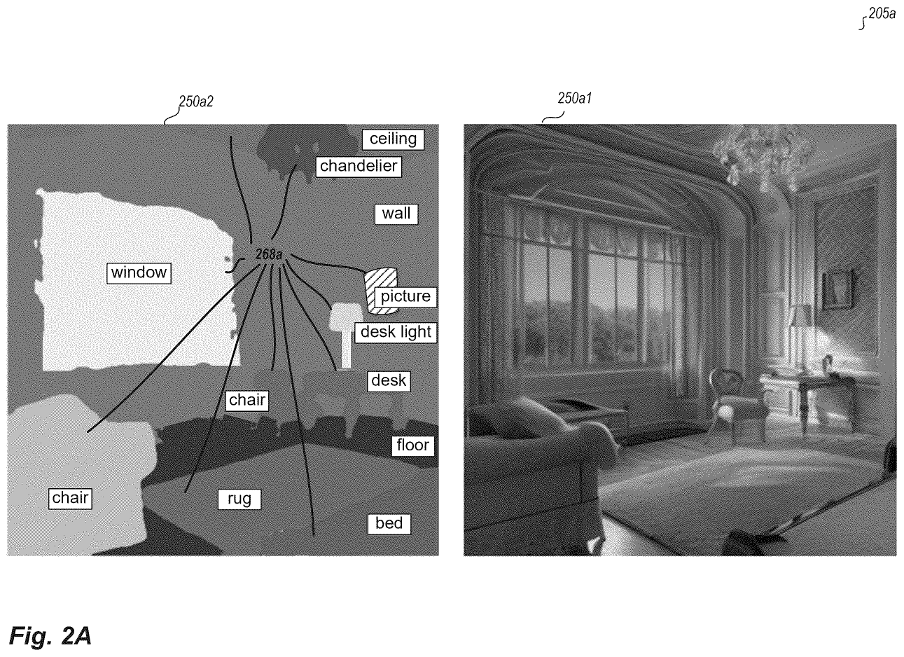

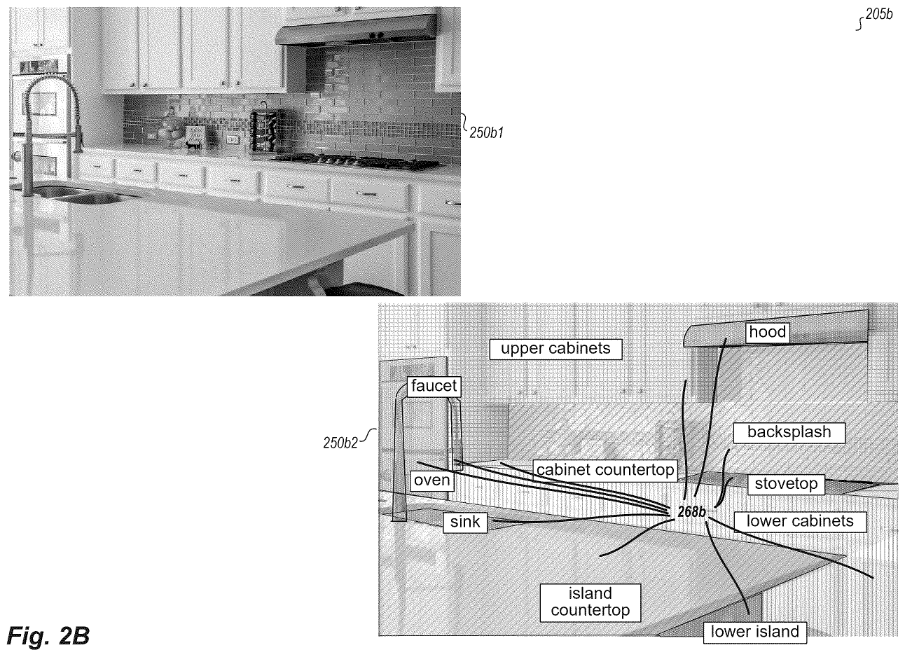

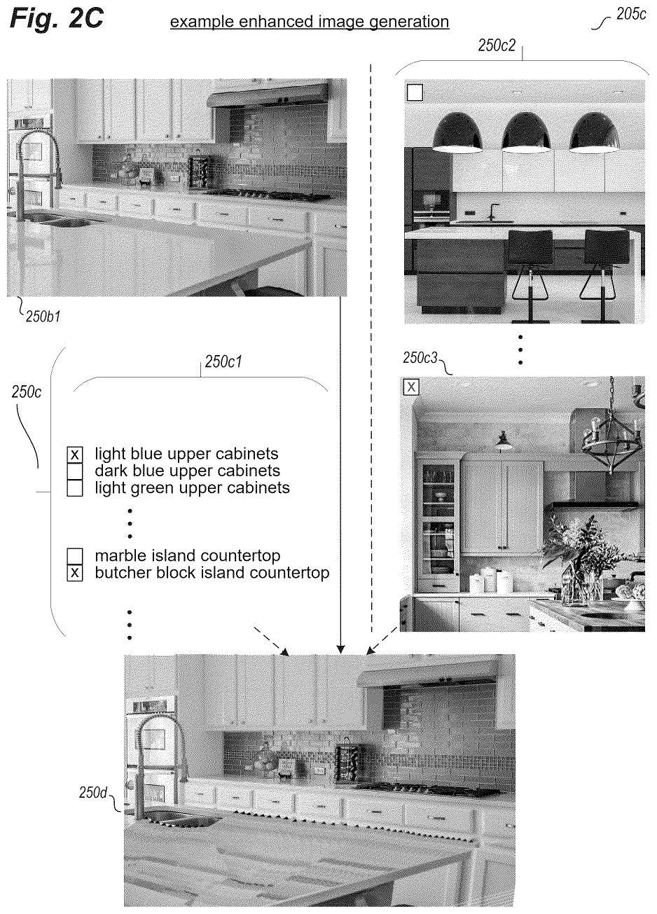

It will be appreciated that various details are provided with respect to FIGS. 1A-1C for illustrative purposes, and are not intended to limit the scope of the invention unless otherwise indicated. Similarly, additional exemplary details are provided with respect to FIGS. 2A-2C and elsewhere herein, and such details are similarly provided for illustrative purposes and are not intended to limit the scope of the invention unless otherwise indicated.

As noted above, the source image to be modified and/or various types of enhancement data to use in its modification may be specified in various manners in various embodiments. For example, in at least some embodiments, the ADIE system may store various dwelling images for a dwelling, and may use some or all of those dwelling images as possible source images to be modified, including in at least some such embodiments to determine a subset of the dwelling images to be used as enhanceable source images in one or more manners (e.g., based on showing visual data for particular types of rooms; based on including particular types of objects in their visual data; based on meeting other criteria, such as with respect to clarity and/or visual coverage of a room or other area; etc.), such as based on automated analysis of the dwelling images and/or based on user selection of particular dwelling images to use. In other embodiments and situations, at least some source images that are modified may instead be supplied by a user who is interacting with the ADIE system. In situations in which the ADIE system uses some or all of its dwelling images as possible source images to be modified, the system may further provide some or all such images to the user for selection, such as for display to the user. In a similar manner, the ADIE system may store information about one or more types of enhancement data that may be used to modify source images, and may similarly present some or all such enhancement data type information to the user for selection. For example, such types of enhancement data may include lists of object types that may be modified, types of modifications that may be made to objects (e.g., to add or remove a particular color and/or pattern or other texture; to add a particular object style, such as to change one type of doorway to another, or to change one type of cabinet facing to another, or to change one type of cabinet hardware to another, or to change one type of flooring or wallcovering to another, etc.), examples of enhancement images that may include particular visual representations of particular objects that may be selected by the user to be applied to another object of the same type in the source image (e.g., that include combinations of two or more objects whose visual attributes correspond to defined object attribute combinations and are to be used to modify two or more corresponding objects of the same type in a source image), etc. In other embodiments and situations, at least some types of enhancement data that is used for modified source images may instead be supplied by a user who is interacting with the ADIE system.

In addition to receiving user indications of or other automated determinations of a particular source image and image enhancement data to use, the ADIE system may in some embodiments and situations receive instructions or other indications from a user or enhancement data use, such as an instruction or indication of a particular type of object in the source image to be modified (e.g., a verbal or written instruction of the object, a selection of a displayed visual pixel mask or other visual representation corresponding to the object, etc.), and/or an instruction or indication of a particular type of modification to make to a corresponding object in the source image (e.g., a particular color to be applied to an indicated object, a particular pattern or other texture to be applied to an indicated object, etc.).

Furthermore, as noted above, the ADIE system may in some embodiments and situations apply one or more color transfer algorithms and/or texture transfer algorithms to an object being modified to change its visual appearance. Nonexclusive examples of such color transfer algorithms and/or texture transfer algorithms include “Color Transfer Between Images” by Erik Reinhard et al., IEEE Computer Graphics and Applications 21(5):34-41, September/October 2001; “Progressive Color Transfer with Dense Semantic Correspondences” by Mingming He et al., Dec. 12, 2018, accessible at https://arxiv.org/pdf/1710.00756; “Arbitrary Style Transfer in Real-Time with Adaptive Instance Normalization” by Xun Huang et al., Jun. 30, 2017, accessible at https://arxiv.org/pdf/1703.06868; “A Closed-Form Solution to Photorealistic Image Stylization” by Yijun Li et al., Jul. 27, 2018, accessible at https://arxiv.org/pdf/1802.06474; and “Semantic Context-Aware Image Style Transfer” by Yi-Sheng Liao et al., IEEE Transactions On Image Processing vol. 31, 2022; all of which are incorporated herein by reference in its entirety.

Additional details are included below regarding performing modifications to particular objects in source images to generate resulting enhanced images, including with respect to the examples of FIGS. 2A-2C.

In addition, in at least some embodiments, some or all search queries may be entered using multiple free-form natural language terms to specify one or more search criteria, and if so the ADIE system may analyze such a query to determine the user-specified criteria to use, including by segmenting the terms in the received query into one or more segments corresponding to one or more indicated search criteria. Such segmenting of the sequence of term(s) may be performed in various manners in various embodiments, including to identify one or more segments for one or more search criteria of one or more specific types, such as one or more of the following: dwelling-type designations (e.g., ‘apartment’, ‘single family house’, ‘condominium’, etc.); POI categories (e.g., “beaches”, “parks”, “schools”, “hospitals”, “lakes”, etc.); indeterminate distance indications that are associated with one or more POI locations and/or POI categories (e.g., “nearby” or analogous terms such as “near”, “by”, “around”, “at”, “close to”, “adjacent”, etc. ; a travel-based distance measure with an indicated travel type, such as walking or bicycling or scootering or driving or bus or train or light rail or mass transit; etc., and an associated amount of travel time that is specified or otherwise determined); non-location-related search filters or other search criteria, such as search criteria related to dwelling attributes (e.g., minimum and/or maximum and/or target price, number of bathrooms, number of bedrooms, etc.), etc. Additional details are included herein related to analyzing a sequence of one or more terms of a received query that is specified using free-form natural language.

For illustrative purposes, some embodiments are described herein in which specific types of information are acquired, used and/or presented in specific ways using specific types of data structures and by using specific types of devices—however, it will be understood that the described techniques may be used in other manners in other embodiments, and that the invention is not limited to exemplary details provided. As one non-exclusive example, specific types of data structures and algorithms are generated and/or used in specific manners in some embodiments, but it will be appreciated that other types of information may be generated and used in other manners in other embodiments, including for types of information other than dwelling information. Similarly, while particular user interface display and interaction techniques are shown, other user interaction techniques may be used in other embodiments. In addition, the term “dwelling” refers herein to any partially or fully enclosed structure in which one or more humans may reside at least some of the time and in which other types of activities may optionally be performed, typically but not necessarily encompassing one or more rooms that visually or otherwise divide the interior space of the structure non-limiting examples of such dwellings include houses, apartment buildings or individual apartments therein, condominiums, supplemental structures on a property with another main building (e.g., a detached accessory dwelling unit), live-work spaces, etc. The term “acquire” or “capture” as used herein with reference to a dwelling interior or exterior, acquisition location, or other location (unless context clearly indicates otherwise) may refer to any recording, storage, or logging of media, sensor data, and/or other information related to spatial characteristics and/or visual characteristics and/or otherwise perceivable characteristics, such as by a recording device or by another device that receives information from the recording device. In addition, various details are provided in the drawings and text for exemplary purposes, but are not intended to limit the scope of the invention-for example, sizes and relative positions of elements in the drawings are not necessarily drawn to scale, with some details omitted and/or provided with greater prominence (e.g., via size and positioning) to enhance legibility and/or clarity, and identical reference numbers may be used in the drawings to identify the same or similar elements or acts.

FIGS. 2A-2C illustrate examples of performing described techniques, including automatically generating and using enhanced dwelling images based on multiple trained machine learning models of multiple types.

In particular, FIG. 2A illustrates information 205a showing one example of an image 250a1, and a resulting image 250a2 that shows various visual pixel mask subsets 268a of the image having subsets of the pixels of the image corresponding to identified objects along with associated label classifications.

FIG. 2B continues the example of FIG. 2A, and shows information 205b that includes another example image 250b1 and a corresponding image 250b2 that shows various visual pixel mask subsets 268b of the image having subsets of the pixels of the image corresponding to an identified object along with an associated label classification-in this example, the images show part of a kitchen, with dwelling-related objects identified that include an oven, stovetop, faucet, sink, island countertop, lower island, lower cabinets, upper cabinets, a cabinet countertop and a backsplash.

FIG. 2C continues the examples of FIGS. 2A-2B, and illustrates information 205c that provides an example of generating an enhanced image based on a specified source image and specified image enhancement data. In particular, in this example, image 250b1 of FIG. 2B is selected by a user (not shown) to be used as the source image (e.g., from multiple presented candidate source images, not shown) 444, and the user further specifies image enhancement data 250c of one or more types. In this example, the user may, for example, be provided with a list of types of image enhancements 250c1, and select one or more of those, including in this example to select to produce an enhanced image that includes light blue upper cabinets and a butcher block island countertop. Alternatively, in some embodiments the user may select from multiple candidate enhancement images 250c2 (or otherwise provide or indicate) an enhancement image that includes visual data of one or more types to be used in the generated enhanced image, such as in this example to indicate to use the upper cabinets and the island countertop shown in the selected enhancement image 250c3, whether by providing textual instructions (not shown) about the portions of the enhancement image to use or otherwise indicating those areas (e.g., circling the objects of interest in the enhancement image, not shown in this example; selecting visual pixel mask or other visual representations corresponding to particular objects, not shown in this example; etc.). The source image 250b1 and selected or otherwise specified enhancement data 250c are then used in this example to generate an enhanced image 250d, by modifying the source image to change the colors of the upper cabinets and the texture of the island countertop in the specified manner, including by using multiple trained ML models (not shown) of multiple types in the manner discussed in greater detail elsewhere herein. It will be appreciated that other types of objects may be modified in other manners in other embodiments.

It will also be appreciated that the examples of FIGS. 2A-2C are provided for illustrative reasons only, and are not intended to limit the scope of the invention. For example, a variety of other combinations of natural language free-form search terms may be used in other embodiments and situations.

In addition, further details related to at least some operations of the ADIE system and its components, including with respect to analyzing images and to analyzing and responding to search queries, are included in U.S. Non-Provisional patent application Ser. No. 18/583,602, filed Feb. 21, 2024 and entitled “Automated Tool For Determining And Providing Building Information For Multiple Partially Described Proximate Geographical Regions”; in U.S. Non-Provisional patent application Ser. No. 18/642,246, filed Apr. 22, 2024 and entitled “Automated Tool For Determining And Using User-Specific Predicted Attributes Of Dwellings That Users Will Later Occupy”; in U.S. Non-Provisional patent application Ser. No. 18/734,815, filed Jun. 5, 2024 and entitled “Automated Tool For Determining And Providing Information About Dwellings Satisfying Search Criteria Specified Using Multiple Data Modes”; in U.S. Non-Provisional patent application Ser. No. 18/622,829, filed Mar. 29, 2024 and entitled “Automated Tool For Determining And Providing Information About Dwellings Within Geographical Regions That Are Determined Specific To Indicated Locations”; and in U.S. Non-Provisional patent application Ser. No. 18/632,217, filed Apr. 10, 2024 and entitled “Automated Tool For Determining And Providing Information About Dwellings Using Heterogenous Search Strategies”; all of which are incorporated herein by reference in its entirety.

Also, additional details related to at least some operations of the ADIE system and its components, including with respect to analyzing images and other data about buildings and other dwellings, are included in U.S. Non-Provisional patent application Ser. No. 16/693,286, filed Nov. 23, 2019 and entitled “Connecting And Using Building Data Acquired From Mobile Devices” (which includes disclosure of an example BICA system that is generally directed to obtaining and using panorama images from within one or more buildings or other structures); in U.S. Non-Provisional patent application Ser. No. 16/236,187, filed Dec. 28, 2018 and entitled “Automated Control Of Image Acquisition Via Use Of Acquisition Device Sensors” (which includes disclosure of an example ICA system that is generally directed to obtaining and using panorama images from within one or more buildings or other structures); and in U.S. Non-Provisional patent application Ser. No. 16/190,162, filed Nov. 14, 2018 and entitled “Automated Mapping Information Generation From Inter-Connected Images”; in U.S. Non-Provisional patent application Ser. No. 16/681,787, filed Nov. 12, 2019 and entitled “Presenting Integrated Building Information Using Three-Dimensional Building Models” (which includes disclosure of an example FMGM system that is generally directed to automated operations for displaying a floor map or other floor plan of a building and associated information); in U.S. Non-Provisional patent application Ser. No. 16/841,581, filed Apr. 6, 2020 and entitled “Providing Simulated Lighting Information For Three-Dimensional Building Models” (which includes disclosure of an example FMGM system that is generally directed to automated operations for displaying a floor map or other floor plan of a building and associated information); in U.S. Non-Provisional patent application Ser. No. 17/080,604, filed Oct. 26, 2020 and entitled “Generating Floor Maps For Buildings From Automated Analysis Of Visual Data From The Buildings'Interiors”; in U.S. Non-Provisional patent application Ser. No. 16/807,135, filed Mar. 2, 2020 and entitled “Automated Tools For Generating Mapping Information For Buildings” (which includes disclosure of an example MIGM system that is generally directed to automated operations for generating a floor map or other floor plan of a building using images acquired in and around the building); in U.S. Non-Provisional patent application Ser. No. 15/950,881, filed Apr. 11, 2018 and entitled “Presenting Image Transition Sequences Between Acquisition Locations”; and in U.S. Non-Provisional patent application Ser. No. 17/013,323, filed Sep. 4, 2020 and entitled “Automated Analysis Of Image Contents To Determine The Acquisition Location Of The Image” (which includes disclosure of an example MIGM system that is generally directed to automated operations for generating a floor map or other floor plan of a building using images acquired in and around the building, and an example ILMM system for determining the acquisition location of an image on a floor plan based at least in part on an analysis of the image's contents); all of which are incorporated herein by reference in its entirety

FIG. 3 is a block diagram illustrating an embodiment of one or more server computing systems 300 executing an implementation of an ADIE system 140, such as in a manner similar to that of FIGS. 1A-1B and with additional hardware details illustrated—the server computing system(s) and ADIE system may be implemented using a plurality of hardware components that form electronic circuits suitable for and configured to, when in combined operation, perform at least some of the techniques described herein. In the illustrated embodiment, a server computing system 300 includes one or more hardware central processing units (“CPU”) or other hardware processors 305, various input/output (“I/O”) components 310, storage 320, and memory 330, with the illustrated I/O components including a display 311, a network connection 312, a computer-readable media drive 313, and other I/O devices 315 (e.g., keyboards, mice or other pointing devices, microphones, speakers, GPS receivers, etc.).

The server computing system(s) 300 and executing ADIE system 140 may communicate with other computing systems and devices via one or more networks 100 (e.g., the Internet, one or more cellular telephone networks, etc.), such as user client computing devices 360 (e.g., used to supply queries; receive responsive answers; and use the received answer information, such as to display or otherwise present answer information to users of the client computing devices and/or to implement further automated activities, such as to access other functionality provided by the ADIE system), optionally other external devices 380 (e.g., used to store and provide dwelling information of one or more types), and optionally other computing systems 390.

In the illustrated embodiment, an embodiment of the ADIE system 140 executes in memory 330 in order to perform at least some of the described techniques, such as by using the processor(s) 305 to execute software instructions of the system 140 in a manner that configures the processor(s) 305 and computing system 300 to perform automated operations that implement those described techniques. The illustrated embodiment of the ADIE system may include one or more components, not shown, to perform portions of the functionality of the ADIE system, and the memory may further optionally execute one or more other programs 335. The ADIE system 140 may further, during its operation, store and/or retrieve various types of data on storage 320 (e.g., in one or more databases or other data structures), such as various types of user data 328, dwelling data 321 (e.g., dwelling images; textual dwelling description data; object data, including as determined from analysis of visual data of dwelling images; etc.), ADIE system data 327, trained semantic segmentation ML model 151a, trained diffusion ML model 151b, candidate enhancement data 323, defined object attribute combination data 324, enhanceable source images 325, specified image enhancement data 196, generated enhanced images 197, identified target dwellings and optionally associated ratings 159, and/or various other types of optional additional information 329.

Some or all of the user client computing devices 360 (e.g., mobile devices), external devices 380, and other computing systems 390 may similarly include some or all of the same types of components illustrated for server computing system 300. As one non-limiting example, the computing devices 360 are shown to include one or more hardware CPU(s) 361, I/O components 362, and memory and/or storage 369, with a browser and/or ADIE client program 368 optionally executing in memory to interact with the ADIE system 140 and present or otherwise use query responses 195 that are received from the ADIE system for submitted user queries 191 (e.g., including generated enhanced images to be presented, candidate source images and/or other candidate image enhancement data to select to be used as part of enhanced image generation, etc.). While particular components are not illustrated for the other devices/systems 380 and 390, it will be appreciated that they may include similar and/or additional components.

It will also be appreciated that computing system 300 and the other systems and devices included within FIG. 3 are merely illustrative and are not intended to limit the scope of the present invention. The systems and/or devices may instead include multiple interacting computing systems or devices, and may be connected to other devices that are not specifically illustrated, including via Bluetooth communication or other direct communication, through one or more networks such as the Internet, via the Web, or via one or more private networks (e.g., mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g., tablets, slates, etc.), database servers, network storage devices and other network devices, smart phones and other cell phones, consumer electronics, wearable devices, digital music player devices, handheld gaming devices, PDAs, wireless phones, Internet appliances, and various other consumer products that include appropriate communication capabilities. In addition, the functionality provided by the illustrated ADIE system 140 may in some embodiments be distributed in various components, some of the described functionality of the ADIE system 140 may not be provided, and/or other additional functionality may be provided.

It will also be appreciated that, while various items are illustrated as being stored in memory or on storage while being used, these items or portions of them may be transferred between memory and other storage devices, such as for purposes of execution, memory management, data integrity, etc. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., by the ADIE system 140 executing on server computing systems 300) and/or data structures, such as by execution of software instructions of the one or more software programs and/or by storage of such software instructions and/or data structures, and such as to perform algorithms as described in the flow charts and other disclosure herein. Furthermore, in some embodiments, some or all of the systems and/or components may be implemented or provided in other manners, such as by consisting of one or more means that are implemented partially or fully in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

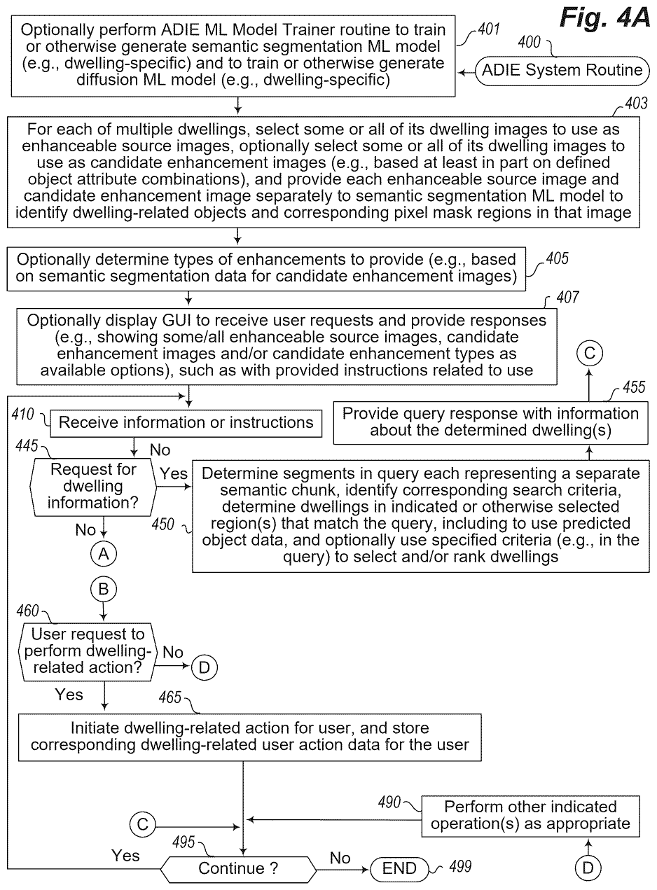

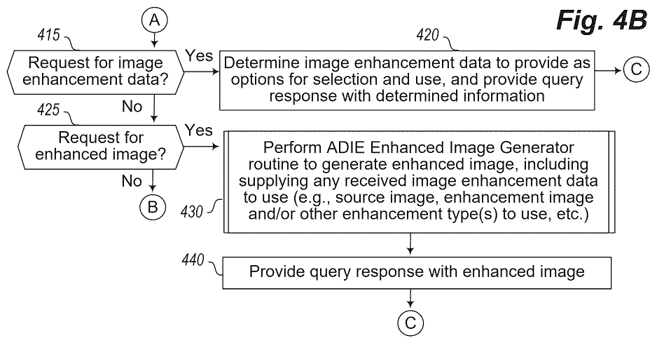

FIGS. 4A-4B are a flow diagram of an example embodiment of an ADIE system routine 400. The routine may be performed as a computer-implemented method provided by, for example, execution of the ADIE system 140 of FIGS. 1A-1B, and/or the ADIE system 140 of FIG. 3, and/or corresponding functionality discussed with respect to FIGS. 2A-2C, such as to perform automated operations related to automatically generating and using enhanced dwelling images based on multiple trained machine learning models of multiple types. In the illustrated embodiment, the routine interacts with a single user at a time, such as to provide dwelling response information to search queries and other requests from that user and/or to provide push messages with information of one or more types, but it will be appreciated that the routine may interact in a similar manner with multiple users (e.g., sequentially or concurrently), and that the routine may in other embodiments perform similar types of activities for other types of information.

In the illustrated embodiment, the routine 400 begins at 401, where it optionally performs a ADIE Machine Learning (ML) Model Trainer routine to train or otherwise generate one or more ML models for subsequent use in generation of enhanced images, such as a trained semantic segmentation ML model (e.g., one trained in a dwelling-specific manner to identify objects typically found in and around dwellings) and/or a trained diffusion ML model (e.g., one trained in a dwelling-specific manner to generate visual renditions of objects typically found in and around dwellings). The routine then continues to block 403 to, for multiple dwellings (e.g., some or all dwellings for which information is available in one or more geographical areas of interest), select some or all dwelling images of that dwelling to use as enhanceable source images, to optionally select some or all of those dwelling images to use as candidate enhancement images (e.g., based at least in part on having visual data that matches defined object attribute combination data), and provides a selected enhanceable source image and candidate enhancement image separately to a trained semantic segmentation ML model to identify dwelling-related objects and corresponding visual pixel masks regions in that image. The routine then continues to block 405, where it optionally determines types of enhancements to provide for use in modified source images to generate enhanced images (e.g., based on semantic segmentation data for candidate enhancement images).

In block 407, the routine then optionally displays a GUI to a current user to receive user requests and/or provide dwelling-related information, and in block 410 receives information or instructions, such as a request from the user via the GUI. In block 445, the routine then determines if the instructions or other information received in block 405 are a request from an end-user for dwelling information, and if so continues to block 450 to determine and provide corresponding information to the end-user. In this example, the operations in block 450 include receiving a search query in a natural language form, determining segments in the query representing separate semantic chunks, identifying corresponding search criteria, determining dwellings in indicated or otherwise selected geographical regions that match the query (e.g., based at least in part on dwelling object information determined in block 403), including to, if user-specific search-related criteria are available, optionally further use such criteria to select and/or rank particular dwellings that are identified. In block 455, the routine then provides a query response with information about the determined dwellings.

It is instead determined in block 445 that the instructions or other information received in block 410 are not an end-user request for dwelling information, the routine continues to block 460 to determine if the instructions or other information received in 410 is an end-user request to perform a dwelling-related interaction, and if so continues to block 465 to initiate one or more indicated dwelling-related interactions for the end-user, such as of a type and in a manner discussed in greater detail elsewhere herein, and to store corresponding dwelling-related user interaction data for the end-user.

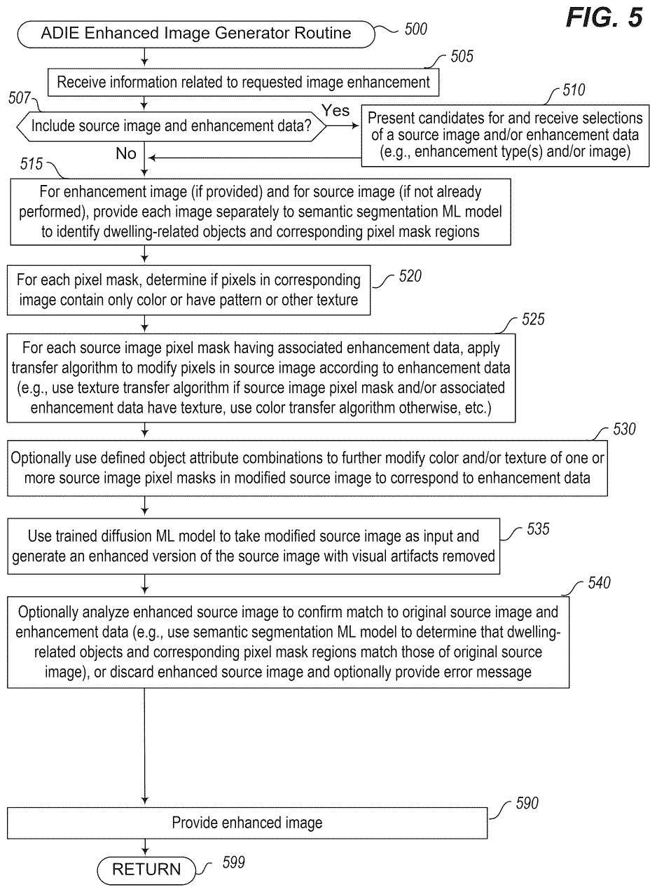

If it is instead determined in block 460 that the instructions or other information received in block 410 is not an end-user request to perform a dwelling-related interaction, the routine proceeds to block 415 to determine if the instructions or other information received in block 410 are a request for image enhancement data of one or more types, such as candidate enhancement data from which the user may select. If so, the routine continues to block 420 to determine and provide image enhancement data as options for selection that correspond to the request, and otherwise continues to block 425 to determine if the instructions or other information received in block 410 are a request to generate an enhanced image. If so, the routine continues to block 430 to perform an ADIE Enhanced Image Generator routine to generate one or more enhanced images based on selected image enhancement data, including to supply as input to the routine any such image enhancement data previously selected and supplied by the user, with one example of such a routine discussed further with respect to FIG. 5. After block 430, the routine continues to block 440 to provide a query response with the generated enhanced image(s) received from block 430.

If it is instead determined in block 425 that the instructions or other information received in block 410 are not a request to generate an enhanced image, the routine continues instead to block 460 to determine if the instructions or other information received in block 410 are a request from the user to perform one or more types of dwelling-related actions, and if so continues to block 465 to initiate the requested dwelling-related action(s) for the user as appropriate, including to store any corresponding dwelling-related user action data for the user. Such dwelling-related actions may include, for example, initiating property inspection activities, initiating dwelling repair activities, initiating dwelling financing activities, initiating dwelling agent representation activities (e.g., touring a dwelling that is available for sale or rent), etc.

if it is instead determined in block 460 that the instructions or other information received in block 410 are not a request to perform one or more dwelling-related actions, the routine continues instead to block 490 to perform one or more other indicated operations as appropriate, with non-exclusive examples of such other operations including retrieving and providing previously determined or generated information (e.g., previous user queries, previously generated enhanced images or other previously determined responses to user queries, previous push messages, etc.), receiving and storing information for later use (e.g., information about dwelling data 321, user data 328, ADIE system data 327, etc.), responding to other types of search queries (e.g., using user-specified filters), receiving and using feedback from a user in response to provided information, providing information about how one or more previous query responses were determined, providing push messages with dwelling-information to particular users if corresponding criteria are satisfied (e.g., in response to previous requests from those users for particular types of dwelling-related information, optionally with one or more specified criteria regarding when to send such push messages), performing housekeeping operations, etc.

After blocks 420, 440, 455, 465 or 490, the routine continues to block 495 to determine whether to continue, such as until an explicit indication to terminate is received (or alternatively only if an explicit indication to continue is received). If it is determined to continue, the routine returns to block 410 to await further information or instructions from the same user, and if not continues to block 499 and ends.

FIG. 5 is a flow diagram of an example embodiment of an ADIE Enhanced Image Generator routine 500. The routine may be performed as a computer-implemented method provided by, for example, execution of the ADIE Enhanced Image Generator component 149 of FIGS. 1A-1B and/or a corresponding component (not shown) of the ADIE system 140 of FIG. 3 and/or with respect to corresponding functionality discussed with respect to FIGS. 2A-2C and elsewhere herein, such as to generate one or more such enhanced images based at least in part on user-supplied instructions and optionally user-selected or otherwise user-specified enhancement data and/or a source image to be enhanced. In addition, in at least some situations, the routine 500 may be performed based on execution of block 430 of FIGS. 4A-4B, with resulting information provided and execution control returning to that location when the routine 500 ends—in other embodiments, the routine may be invoked in other manners. In this example, the routine 500 is performed using multiple particular ML models of multiple particular types, but in other embodiments may use other techniques to generate enhanced images, whether in addition to or instead of the illustrated types of techniques.

The illustrated embodiment of the routine 500 begins at block 505, where it receives, as input, data related to requested image enhancement from a user's instructions or other supplied information, which may include instructions related to one or more types of modifications to make to one or more types of objects, optionally including additional image enhancement data (e.g., a source image to be enhanced, and/or one or more enhancement images from which to use visual data in modifying the source image, and/or indications of one or more objects in the source image to modify, and/or indications of one or more types of modifications to make to one or more indicated objects, etc.)—in at least some embodiments and situations, some or all of the received data may be based on selections previously made by a user from candidate options provided to the user. In block 507, the routine determines if the data received includes a source image and sufficient image enhancement data to specify how to modify the source image to generate one or more resulting enhanced images (e.g., data for multiple defined types, such as which one or more objects to modify in which source image, how to modify such an object, etc.), and if so proceeds to block 515. Otherwise, the routine continues to block 510, where it determines and presents candidates to the user for a source image (if not already specified) and/or for image enhancement data of one or more types (if not already specified), and receives corresponding selections from the user (e.g., using enhanceable source images or other dwelling images; candidate enhancement images and/or enhancement types; a list of object types, such as corresponding to objects visible in provided dwelling images or more generally associated with particular dwelling rooms or other areas; etc.), and then proceeds to block 515. In block 515, the routine then, for the indicated source image and any enhancement images that are provided, supplies an image separately to the trained semantic segmentation ML model to cause it to identify dwelling-related objects and corresponding visual pixel mask regions in that image. In block 520, the routine then, for a visual pixel mask from block 515 (or at least those corresponding to indicated objects or object types to be modified), determines if the pixels within that mask contain only color data without patterns or other textures (e.g., accounting for shading or otherwise for differing light conditions) or instead have a pattern or other texture across the visual pixel mask. In block 525, the routine then, for a source image visual pixel mask of an object type to be modified and having associated enhancement data to use for the modification, applies a transfer algorithm to modify pixels in the source image for that pixel mask according to the associated enhancement data (e.g., to use a texture transfer algorithm if the source image pixel mask and/or associated enhancement data for that pixel mask contain patterns or other texture data, or to otherwise use a color transfer algorithm).

In block 530, the routine then optionally uses defined object attribute combination data to further modify the color and/or texture of one or more source image pixel masks in the modified source image resulting from block 525 in order to correspond to further enhancement data—in at least some embodiments and situations, such further enhancement data may include combinations of colors and/or textures to use in different associated types of objects (e.g., if an upper cabinet color is specified to be X, then use a complementary or contrasting Y color for the backsplash or wall paint color; if a countertop has a pattern or other texture corresponding to a particular type of natural stone or butcher block, then use a complementary or contrasting specified color or texture for the flooring; etc.). After block 530, the routine in block 535 uses a trained diffusion ML model to take the current modified source image as input and to generate an enhanced version of the source image with visual artifacts removed, such as based on providing corresponding instructions to modify only visual data for the objects in the modified source image that had been previously modified and/or to remove only visual artifacts without making other changes. In block 540, the routine then optionally analyzes the enhanced source image to validate it, such as to confirm a match to the original source image and enhancement data (e.g., to ensure that the diffusion model has not made changes other than those instructed), and if such validation is performed and fails, the routine may further discard the enhanced source image and optionally provide a corresponding error message, or may otherwise restart the process at block 515 with changed instructions (e.g., for the trained diffusion ML model) and/or changed enhancement data—in some embodiments and situations, the validation may include using the semantic segmentation ML model to determine that dwelling-related objects and corresponding pixel masks regions in the enhanced source image match those of the original source image within a defined amount of difference. After block 540, the routine then provides the enhanced image(s) as output in block 590 (e.g., unless the optional validation activities are performed and the generated enhanced image fails to be validated), and continues to block 599 and returns.

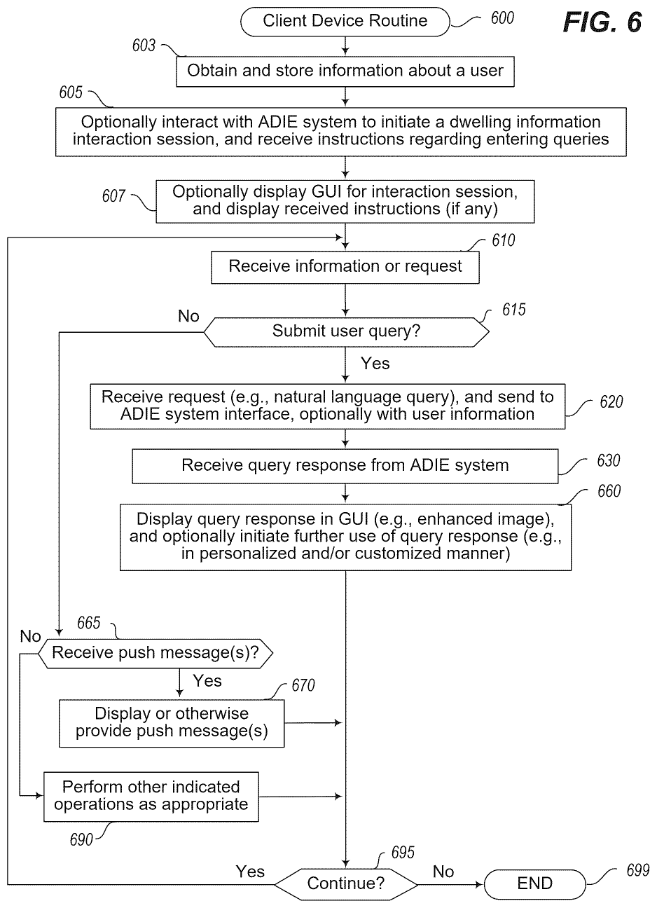

FIG. 6 is a flow diagram of an example embodiment of a client device routine 600. The routine may be performed as a computer-implemented method provided by, for example, operations of a client computing device 360 of FIGS. 1A-1B and/or a client computing device 360 of FIG. 3 and/or with respect to corresponding functionality discussed with respect to FIGS. 2A-2C and elsewhere herein, such as to interact with users or other entities who submit queries (or other requests or information) to the ADIE system, to receive responsive answers (or other information) from the ADIE system, and to optionally use the received information in one or more manners (e.g., to automatically initiate follow-up activities in accordance with a received responsive answer or other received information).

The illustrated embodiment of the routine 600 begins at block 603, where information is optionally obtained and stored about the user, such as for later use in personalizing or otherwise customizing further actions to that user. The routine then continues to block 605 to optionally interact with the ADIE system to initiate an interaction session (e.g., in response to a corresponding instruction from the user), as well as to optionally receive a greeting and/or introductory instructions regarding using a GUI of the ADIE system, such as by displaying a GUI for the interaction session in block 607 in which the received greeting and/or introductory instructions (if any) are optionally displayed, as well as listing various selections for use as search criteria and/or browsing filter criteria (e.g., indications of one or more new object classes that the enhanced ML model supports) and/or related to generating enhanced images. The routine then continues to perform blocks 610-690 as part of participating in the interaction session or otherwise receiving push messages sent from the ADIE system.

In particular, the routine continues to block 610 after block 607, where it waits until information or a request is received from the user. In block 615, the routine determines if the information or request received in block 610 is a request to be submitted, such as a search query (e.g., in a natural language format, such as freeform text) or browse query or a request related to generating an enhanced image, and if not continues to block 665. Otherwise, the routine continues to block 620, where it sends the received query to the ADIE system interface, optionally along with additional information about the user from block 603, to obtain a corresponding responsive answer—in other embodiments, the routine may further modify the received user query to personalize and/or customize the information to be provided to the ADIE system (e.g., to add information specific to the user, such as location, demographic information, preference information, etc.). In block 630, the routine then receives a responsive answer to the query from the ADIE system, and in block 660 displays the received query response in the GUI (e.g., a generated enhanced image), and optionally initiates further use of the query response in one or more manners (e.g., in a manner that is personalized and/or customized for the user)—in some embodiments, the further initiated activities may include invoking of other functionality of the ADIE system for a user-initiated dwelling-related action, such as to initiate an inspection process for a selected dwelling indicated in dwelling information search results, to initiate a mortgage application process for a selected dwelling indicated in dwelling information search results, to initiate matching the user with a real estate professional as part of a housing search based on corresponding response information received from the ADIE system, etc.

In block 665, the routine determines if the information or request received in block 610 is one or more push electronic messages sent by the ADIE system, and if so continues to block 670 to display or otherwise provide the received electronic messages to the user (e.g., stores the received electronic messages in a queue for later retrieval by the user)—in some embodiments and situations, such a displayed or otherwise provided electronic message may include one or more user-selectable controls that, if selected by the user, initiate further interactions with the ADIE system or otherwise initiate further activities of one or more types. If it is instead determined in block 665 that the information or request received in block 610 is not one or more push electronic messages, the routine continues to block 690 to instead perform one or more other indicated operations as appropriate, with non-exclusive examples including sending information to the ADIE system of other types (e.g., based on selections by the user of provided user-selectable controls), receiving and storing user data for later use in personalization and/or customization activities, receiving and responding to requests for information about previous user queries and/or corresponding responsive answers for a current user and/or client device, receiving and responding to indications of one or more housekeeping activities to perform, etc. After blocks 660, 670 or 690, the routine continues to block 695 to determine whether to continue, such as until an explicit indication to terminate is received (or alternatively only if an explicit indication to continue is received). If it is determined to continue, the routine returns to block 610, and if not continues to block 699 and ends.

It will be appreciated that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, synchronously or asynchronously, etc.) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the claims that are specified and the elements recited therein. In addition, while certain aspects of the invention may be presented at times in certain claim forms, the inventors contemplate the various aspects of the invention in any available claim form. For example, while only some aspects of the invention may be recited at a particular time as being embodied in a computer-readable medium, other aspects may likewise be so embodied.

What is claimed is:

1. A computer-implemented method comprising:
obtaining, by one or more computing devices, indications of a source image that is captured in a room of a dwelling and that has visual data including a plurality of red-green-blue (RGB) pixels showing multiple objects in the room, and of a type of color enhancement to make to first pixels associated with a first of the multiple objects of a first indicated object type, and of a type of texture enhancement to make to second pixels associated with a second of the multiple objects of a second indicated object type;
determining, by the one or more computing devices and using a trained semantic segmentation machine learning model, multiple visual masks for the source image that are associated with respective objects of the multiple objects and that identify respective groups of pixels in the plurality of RGB pixels having respective associated object type label classifications for the associated respective object for that visual mask;
determining, by the one or more computing devices, a first visual mask of the multiple visual masks having a first group of the first pixels that show the first object based at least in part on the associated object type label classification for the first visual mask matching the first indicated object type, and a second visual mask of the multiple visual masks having a second group of the second pixels that show the second object based at least in part on the associated object type label classification for the second visual mask matching the second indicated object type;
generating, by the one or more computing devices, a modified version of the source image, including using a defined color transfer algorithm to modify color values of the first pixels of the first pixel group based on the type of color enhancement, and including using a defined texture transfer algorithm to modify color values of the second pixels of the second pixel group based on the type of texture enhancement;
generating, by the one or more computing devices and using a trained diffusion machine learning model, an enhanced version of the source image by providing instructions to the trained diffusion machine learning model to cause removal of visual artifacts in the modified version of the source image that result from modifying of the color values of the pixels of the first and second pixel groups; and
presenting, by the one or more computing devices, the enhanced version of the source image.

2. The computer-implemented method of claim 1 further comprising validating, by the one or more computing devices and before the presenting of the enhanced version of the source image, the generated enhanced version of the source image, including using the trained semantic segmentation machine learning model to determine a plurality of visual masks for the generated enhanced version of the source image, and determining that first positions for the plurality of visual masks for the generated enhanced version of the source image differ from second positions for the multiple visual masks for the source image by at most a defined difference threshold.

3. The computer-implemented method of claim 1 further comprising validating, by the one or more computing devices and before the presenting of the enhanced version of the source image, the generated enhanced version of the source image, including using the trained semantic segmentation machine learning model to determine a plurality of visual masks for the generated enhanced version of the source image, and determining using a pixel-wise cross-entropy metric that the plurality of visual masks for the generated enhanced version of the source image differ from the multiple visual masks for the source image by at most a defined difference threshold.

4. The computer-implemented method of claim 1 further comprising determining, by the one or more computing devices, that the second pixels associated with the second object in the source image have an existing first texture, wherein the type of texture enhancement is to use a second texture different from the first texture, and wherein the using of the defined texture transfer algorithm to modify color values of the second pixels of the second pixel group is performed based on the second pixels having the existing first texture and includes modifying the color values of the second pixels of the second pixel group to use the second texture.

5. The computer-implemented method of claim 4 wherein the first and second textures are different patterns.

6. The computer-implemented method of claim 1 wherein the obtaining of the indication of the type of texture enhancement to make to the second pixels includes at least one of:
receiving, by the one or more computing devices, an indication to use a first type of texture shown in a selected one of a first plurality of presented images showing a plurality of textures, and wherein the type of texture enhancement to make is to use the first type of texture for the second pixels associated with the second object; or
receiving, by the one or more computing devices, an indication of a target object that has a second type of texture and is shown in a selected one of a second plurality of presented images showing a plurality of objects having a plurality of textures, and wherein the type of texture enhancement to make is to use the second type of texture for the second pixels associated with the second object; or
receiving, by the one or more computing devices, an indication of a target object in a supplied image that has a third type of texture, and wherein the type of texture enhancement to make is to use the third type of texture for the second pixels associated with the second object; or
receiving, by the one or more computing devices, a selection of the type of texture enhancement to make from provided descriptions of a plurality of candidate types of texture enhancements.

7. The computer-implemented method of claim 1 further comprising determining, by the one or more computing devices, that the first pixels associated with the first object in the source image do not have an existing texture and do have at least one existing first color, wherein the type of color enhancement is to use at least one second color different from the at least one first color, and wherein the using of the defined color transfer algorithm to modify color values of the first pixels of the first pixel group is performed based on the first pixels not having the existing texture and includes modifying the color values of the first pixels of the first pixel group to use the at least one second color.

8. The computer-implemented method of claim 1 wherein the obtaining of the indication of the type of color enhancement to make to the first pixels includes at least one of:
receiving, by the one or more computing devices, an indication to use a first color shown in a selected one of a first plurality of presented images showing a plurality of colors, and wherein the type of color enhancement to make is to use the first color for the first pixels associated with the first object; or
receiving, by the one or more computing devices, an indication of a target object that has a second color and is shown in a selected one of a second plurality of presented images showing a plurality of objects having a plurality of colors, and wherein the type of color enhancement to make is to use the second color for the first pixels associated with the first object; or
receiving, by the one or more computing devices, an indication of a target object in a supplied image that has a third color, and wherein the type of color enhancement to make is to use the third color for the first pixels associated with the first object; or
receiving, by the one or more computing devices, a selection of the type of color enhancement to make from provided descriptions of a plurality of candidate types of color enhancements.

9. The computer-implemented method of claim 1 wherein the type of color enhancement is to use an indicated first color with the first pixels associated with the first object, and wherein the method further comprises:
selecting, by the one or more computing devices, a second color that is complementary with the first color,
and wherein the generating of the modified version of the source image further includes using the defined color transfer algorithm to modify color values of third pixels of a third pixel group associated with a third object of the multiple objects to use the second color.

10. The computer-implemented method of claim 9 further comprising:
presenting, by the one or more computing devices and after the selecting of the second color, information about one or more candidate colors that include the second color to use with one or more candidate objects that include the third object,
and wherein the using of the defined color transfer algorithm to modify the color values of the third pixels to use the second color is performed in response to instructions received based on the presenting of the information.

11. The computer-implemented method of claim 1 wherein the type of texture enhancement is to use an indicated first texture with the second pixels associated with the second object, and wherein the method further comprises:
selecting, by the one or more computing devices, a second texture that is complementary with the first texture,
and wherein the generating of the modified version of the source image further includes using the defined texture transfer algorithm to modify color values of third pixels of a third pixel group associated with a third object of the multiple objects to display the second texture.

12. The computer-implemented method of claim 1 wherein the obtaining of the indications of the source image and of the type of color enhancement and of the type of texture enhancement includes receiving a supplied identification of the source image and receiving identifications of the first and second objects, and wherein the identification of the first and second objects includes at least one of a received verbal description of the first and second objects, or received indications of respective first and second locations within the source image of the first and second objects, or one or more indications of respective first and second categories of the first and second objects.

13. The computer-implemented method of claim 1 further comprising performing, by the one or more computing devices and before the determining of the multiple visual masks for the source image, training of the semantic segmentation machine learning model using training data for a plurality of captured images showing objects in one or more dwellings.

14. The computer-implemented method of claim 1 wherein the semantic segmentation machine learning model is a neural network model, and wherein the method further comprises selecting, by the one or more computing devices, the plurality of captured images for the training data from images captured at the dwelling to train the semantic segmentation machine learning model specific to the dwelling.

15. A system comprising:
one or more hardware processors of one or more computing systems; and
one or more memories with stored instructions that, when executed by at least one of the one or more hardware processors, cause the one or more computing systems to perform automated operations including at least:
obtaining indications of a source image captured in a room of a dwelling and having visual data including a plurality of pixels showing multiple objects in the room, and of a type of enhancement to make to some pixels of the plurality of pixels that are associated with one object of the multiple objects;
determining, using a trained semantic segmentation machine learning model, multiple visual masks for the source image that are associated with respective objects of the multiple objects of the source image, the multiple visual masks identifying respective groups of pixels of the plurality of pixels and having respective associated object type label classifications corresponding to the associated respective object for that visual mask, the multiple visual masks including a first visual mask having a first group of pixels showing the one object;
generating, using one or more defined transfer algorithms, a modified version of the source image, including modifying, based on the type of enhancement, color values of the pixels of the first group of pixels;
generating, using a trained diffusion machine learning model, an enhanced version of the source image by providing instructions to the trained diffusion machine learning model to cause removal of visual artifacts in the modified version of the source image resulting from the modifying of the color values of the pixels for the first group; and
providing the enhanced version of the source image for display.

16. The system of claim 15 wherein the type of enhancement to make to the some pixels is to change one or more colors of the some pixels to one or more indicated new colors, and wherein the modifying of the color values of the pixels of the first group of pixels includes using a defined color transfer algorithm to modify the color values of the pixels of the first group of pixels to the one or more indicated new colors.

17. The system of claim 15 wherein the type of enhancement to make to the some pixels is to change a texture of the some pixels to an indicated new texture, and wherein the modifying of the color values of the pixels of the first group of pixels includes using a defined texture transfer algorithm to modify the color values of the pixels of the first group of pixels to use the new texture.

18. A non-transitory computer-readable medium having stored contents that cause one or more computing devices to perform automated operations including at least:
obtaining, by the one or more computing devices, indications of a source image captured in an area of a dwelling and having visual data including a plurality of pixels showing multiple surfaces in the area, and of one or more types of enhancements to make to some pixels of the plurality of pixels that are associated with one or more surfaces of the multiple surfaces;
determining, by the one or more computing devices and using a trained semantic segmentation machine learning model, multiple visual masks for the source image that are associated with respective surfaces of the multiple surfaces of the source image and that identify respective groups of pixels of the plurality of pixels having associated respective label classifications;
generating, by the one or more computing devices and using one or more defined transfer algorithms, a modified version of the source image, including modifying color values of pixels of the respective groups of pixels for one or more of the visual masks associated with the one or more surfaces;
generating, by the one or more computing devices and using a trained diffusion machine learning model, an enhanced version of the source image by providing instructions to the trained diffusion machine learning model to cause removal of visual artifacts in the modified version of the source image from the modifying of the color values of the pixels for the one or more surfaces; and
providing, by the one or more computing devices, the enhanced version of the source image for display.

19. The non-transitory computer-readable medium of claim 18 wherein the area of the dwelling is a room of the dwelling, wherein the one or more types of enhancements to make to the some pixels includes changing one or more colors of the some pixels to one or more indicated new colors, and wherein the modifying of the color values of the pixels of the group of pixels for the visual mask associated with one surface of the one or more surfaces includes using a defined color transfer algorithm to modify the color values of the pixels of that group of pixels to at least one of the one or more indicated new colors.

20. The non-transitory computer-readable medium of claim 18 wherein the area of the dwelling is a room of the dwelling, wherein the one or more types of enhancements to make to the some pixels includes changing a texture of the some pixels to an indicated new texture, and wherein the modifying of the color values of the pixels of the group of pixels for the visual mask associated with one surface of the one or more surfaces includes using a defined texture transfer algorithm to modify the color values of the pixels of that group of pixels to use the new texture.
